(19) United States
(12) Patent Application Publication
(10) Pub. No.: US 2015/0122131 A1
(43) Pub. Date: May 7, 2015

(54) METHOD AND DEVICE FOR GRINDING COFFEE BEANS

(71) Applicant: KONINKLIJKE PHILIPS N.V., EINDHOVEN (NL)

(72) Inventors: Mart Kornelis-Jan Te Velde, Eindhoven (NL); Jan Frederik Suijver, Eindhoven (NL); Job Lipsch, Eindhoven (NL); Johan Marra, Eindhoven (NL); Jeroen Alphons Pikkkemaat, Eindhoven (NL); Karel Johannes Adrianus Van Den Aker, Eindhoven (NL); Gerben Kooljman, Eindhoven (NL); Nicolaas Petrus Willard, Eindhoven (NL); Nicole Petronella Martien Haex, Eindhoven (NL); Jeroen Herman Lammers, Eindhoven (NL); Zhuangxiong Huang, Eindhoven (NL)

(21) Appl. No.: 14/396,992

(22) PCT Filed: Apr. 23, 2013
(86) PCT No.: PCT/IB2013/053191

§ 371 Date: Oct. 24, 2014

Related U.S. Application Data
(60) Provisional application No. 61/639,139, filed on Apr. 27, 2012.

(51) Int. Cl. A47J 42/16; A47J 31/42

(52) U.S. Cl. CPC A47J 42/16; A47J 31/42
USPC 99/286; 241/6; 241/250; 241/257.1

(57) ABSTRACT

In a method for grinding coffee beans (5), the beans (5) are ground off bit by bit by applying a device (1) comprising two tools (20; 40, 42), wherein one of the tools (20; 40, 42) is a grinding tool (20) having an abrasive surface (21), wherein the beans (5) and the abrasive surface (21) are made to contact each other and to perform a relative movement with respect to each other, and wherein another of the tools (20; 40, 42) is a bean delimiting tool (40, 42) having a surface (44) against which the beans (5) are retained during the time that they are in contact with the abrasive surface (21). By grinding off coffee beans (5) instead of crushing coffee beans (5) in a conventional manner, it is achieved that the grinding process can be performed at a relatively high speed and a relatively low torque.

### FIELD OF THE INVENTION

The present invention relates to a method for grinding coffee beans, wherein a device comprising a grinding tool having an abrasive surface is applied, and wherein the coffee beans and the abrasive surface are made to contact each other and to perform a relative movement with respect to each other.

The present invention also relates to a device for grinding coffee beans, comprising a grinding tool having an abrasive surface.

### BACKGROUND OF THE INVENTION

A device for grinding coffee beans, which will hereinafter be referred to as grinder, is known. It is possible for a grinder to be integrated in a coffee maker, i.e. a device comprising a brewing space for allowing coffee extract to interact with water. However, that does not alter the fact that a grinder may also be a stand-alone device.

U.S. Pat. No. 7,984,868 discloses a grinder which comprises grinding burrs, one of which is rotated by a drive motor. The other of the burrs is generally non-rotatable with regard to the general grinding operation. The two grinding burrs are provided with grinding surfaces against which coffee beans are ground. The grinding surfaces are spaced a desired dimension away from each other to produce a desired grind of coffee. In order to adjust one of the burrs relative to the other burr and to maintain the burr adjustments, a burr adjuster assembly is provided, which may comprise a threaded structure.

In use, coffee beans are drawn into position between the grinding surfaces by means of an auger. Ground material produced by the grinding operation is expelled through an outlet passage. The grind size can be adjusted on the basis of the fact that the gap between the burrs can be adjusted.

Almost all fully automatic espresso machines, i.e. machines which are adapted to make coffee on the basis of coffee beans and water at a certain pressure, comprise a grinder having grinding burrs as described in the foregoing. Such a grinder has a significant impact on the bill of material of a fully automatic espresso machine. In many practical cases, the grinding burrs of the grinder comprise ceramic burr discs, which are relatively expensive components. Also, in many practical cases, a high transmission ratio is needed, for example a ratio of about 1:50, from the drive motor to the driven grinding burr, so that it is necessary to apply a relatively expensive gearbox. Furthermore, there is a high drift in grind size at the beginning of the lifetime of the known grinder, due to wear and tear, and the known grinder makes a lot of noise during use.

### SUMMARY OF THE INVENTION

It is an object of the present invention to provide a grinder which can be cheaper and smaller than the known grinders, while maintaining a desired level of effectiveness of grinding processes to be performed by means of the grinder. The object is achieved by introducing a new way of grinding coffee beans. In particular, the present invention provides a method for grinding coffee beans, wherein the coffee beans are ground off bit by bit by applying a device comprising two tools, wherein one of the tools is a grinding tool having an abrasive surface, wherein the coffee beans and the abrasive surface are made to contact each other and to perform a relative movement with respect to each other, and wherein another of the tools is a bean delimiting tool having a surface against which the coffee beans are retained during the time that they are in contact with the abrasive surface.

According to the state of the art, a process of grinding coffee beans involves subjecting the coffee beans to a crushing action. In the process, the driven grinding burr is made to rotate at a relatively low speed, for example, a speed which is lower than 600 revolutions per minute, while high torque is needed, which often has maxima which are significantly higher than 1.0 Nm. Therefore, a gearbox is often applied in a grinder, as mentioned in the foregoing, or the drive motor needs to be heavy and bulky, which is not desirable in the context of a grinder which is used as a consumer product in people's homes and which is not expected to occupy much space or to be a relatively expensive product.

In the context of the present invention, another principle of grinding coffee beans is proposed. In particular, the present invention is about grinding off coffee beans bit by bit. Words like scraping off and shaving off might also be used to describe what is happening to the coffee beans in such a type of grinding process. It is noted that the coffee beans may be subjected to a crushing action first, so that a number of coffee bean pieces are obtained, which are subsequently subjected to the grinding action as mentioned. In other words, the present invention also covers a process in which the coffee beans are subjected to a grinding action while being in a state in which they are divided in a number of pieces.

An advantage of the new principle of grinding coffee beans is that it is possible to use only one grinding tool having an abrasive surface, and that such a grinding tool can be driven at a relatively high speed and a relatively low torque, so that a relatively small drive motor can be applied and it is possible to use a small gearbox for realizing a low transmission ratio, for example a ratio of 1:5 or 1:7, or to even avoid the application of a gearbox. Preferably, when the method according to the present invention is carried out, the grinding tool can be rotated in order to have the required relative movement of the coffee beans and the abrasive surface, wherein rotation takes place at a speed which is at least 500 revolutions per minute, preferably at least 1,000 revolutions per minute, and which may even be as high as 15,000 revolutions per minute. Furthermore, it is preferred if the typical torque at which the grinding tool is driven is not higher than 2 Nm, preferably not higher than 1 Nm. It may be even so that a typical torque which is lower than 0.2 Nm is sufficient for driving the grinding tool and letting the grinding tool continually grind off bits of coffee beans. In this way, targets in respect of mass flow of the coffee beans can be achieved. For example, it may be desirable for the mass flow to be at least 10 grams per 10 seconds. Furthermore, there is a possibility of using a low-cost motor. A maximum start-up torque may be 5 Nm, preferably 2.5 Nm, for the motor as may be used in combination with a small gearbox.

In a practical case, the speed may be 1,500 revolutions per minute, which involves a typical average torque in a range of 0.2 Nm to 0.4 Nm. In such a case, peak torques may typically be in a range of 0.6 Nm to 0.8 Nm, which may be accounted for by applying a gearbox having a transmission ratio of 1:7, for example, which is also useful for accounting for the start-up torque.

Besides the method for grinding coffee beans as described in the foregoing, the present invention provides a device for grinding coffee beans, i.e. a grinder. In general, this grinder comprises a grinding tool having an abrasive surface, a bean delimiting tool for putting the coffee beans and the grinding tool in a position for contacting each other, having a surface for retaining the coffee beans in such position, and means for realizing a relative movement of the coffee beans and the abrasive surface. When the relative movement as mentioned is realized, the actual grinding process takes place. According to the present invention, during this process, the coffee beans are gradually ground away under the influence of contact to the abrasive surface, while being retained by the surface of the bean delimiting tool, which can be a non-abrasive surface. When the grinder according to the present invention is applied, crushing of the coffee beans may occur, but, different from known grinding processes, this is not the only or primary way in which the coffee beans are transformed into powder.

For sake of clarity, it is noted that a tool like a stationary grinding burr having an abrasive surface as known in the art cannot be regarded as an embodiment of the bean delimiting tool according to the present invention. During operation of a set of grinding burrs, the coffee beans are continually displaced between the grinding burrs. The abrasive surface of the stationary grinding burr is only designed for performing an abrasive action on the coffee beans, wherein it is not possible to find a functionality of putting the coffee beans in a certain position with respect to the rotatable grinding burr and retaining the coffee beans in such position. This may be understood even better in view of the fact that it is possible for the bean delimiting tool according to the present invention to have a smooth surface, whereas this is not possible for the surface of the stationary grinding burr according to the state of the art.

In conformity with what is mentioned in the foregoing, it may be possible to dispense with a gearbox when the present invention is applied. Hence, it is possible for the grinding tool to be directly connected to an outgoing shaft of a motor which is provided for driving the grinding tool.

The abrasive surface of the grinding tool may be a sandpaper surface. An advantage of such an embodiment of the abrasive surface is relatively low costs. Furthermore, the surface can be easily replaceable, so that effectiveness of the grinding process to be performed by means of the surface can be maintained at an acceptable level.

In a practical embodiment of the grinder according to the present invention, the relative movement of the coffee beans and the abrasive surface can be realized on the basis of a rotatable arrangement of the grinding tool. In that case, it is preferred if the grinding tool is driven at a relatively high speed and a relatively low torque in comparison with prior art situations. In particular, the means for realizing a relative movement of the coffee beans and the abrasive surface may be adapted to rotate the grinding tool at a speed which is at least 500 revolutions per minute, preferably at least 1,000 revolutions per minute, and at a typical torque which is at most 2 Nm, preferably at most 1 Nm, wherein it is most preferred if the typical torque can be even lower than 0.2 Nm, as mentioned earlier. In that case, a relatively light and small motor can be used in the grinder, and the grinding tool can be driven directly by the motor without application of a gearbox, while it is still possible to have an effective grinding process. That does not alter the fact that it may be practical to apply a gearbox, which only needs to be a small gearbox having a low transmission ratio.

In a first basic embodiment, the grinder according to the present invention comprises a bean positioning unit defining a space for accommodating a coffee bean, the space being open to an area of the abrasive surface of the grinding tool, wherein at least one of the grinding tool and at least a component of the bean positioning unit is movably arranged in a first direction, for varying a distance between the abrasive surface and at least a component of the bean positioning unit, and wherein at least one of the grinding tool and the bean positioning unit is movably arranged in a second direction which is different from the first direction, for varying areas of the abrasive surface facing the open space of the bean positioning unit.

According to the present invention, a grinder is provided which can do without the grinding burrs as known from the prior art, wherein it is sufficient to apply only one grinding tool having an abrasive surface. In the first basic embodiment of the grinder, a bean positioning unit is provided for realizing that a coffee bean is put in contact with the abrasive surface and pressed against the surface until the coffee bean is ground away. For the purpose of performing the pressing action, at least one of the grinding tool and at least a component of the bean positioning unit is movably arranged in a first direction, for varying a distance between the abrasive surface and at least a component of the bean positioning unit. In this way, it is achieved that when a coffee bean which is held against the abrasive surface gets smaller during a grinding process, the grinding process can still be continued until most of the coffee bean is gone. Furthermore, in order to achieve that a coffee bean is continually exposed to other areas of the abrasive surface, and that there is a continuous relative movement of the coffee beans and the abrasive surface, which is important in a grinding process, at least one of the grinding tool and the bean positioning unit is movably arranged in a second direction which is different from the first direction. When the grinding tool comprises a disc, the first direction can be a direction which coincides with a direction in which a longitudinal axis or rotation axis of the disc extends, while the second direction can be a direction perpendicular to the first direction, i.e. a direction defined by the general orientation of the abrasive surface.

According to the state of the art, a number of coffee beans are ground at one time, wherein the coffee beans are introduced between the abrasive surfaces of two grinding burrs, which are rotated with respect to each other. In the first basic embodiment of the grinder according to the present invention, one coffee bean at a time can be pressed against an abrasive surface, wherein the coffee bean is ground under the influence of a relative movement between the bean and the abrasive surface. Processing less coffee beans at one time results in a lower torque. By having a higher speed, it is still possible to realize a practical grind flow (amount of coffee grind per time period, typically 10 grams per 10 seconds). For sake of completeness, it is noted that the relative moment can be of a rotational nature, but that does not alter the fact that the movement can be another type of movement, including a reciprocating linear movement. Also in case the movement is a rotational movement, it is possible for such movement to be a reciprocating movement as well.

When the first basic embodiment of the grinder according to the present invention is used, coffee beans are ground by causing them to be pressed against an abrasive surface. Under the influence of the pressure and a relative movement between the coffee beans and the abrasive surface, which causes the coffee beans to be continually exposed to different areas of the abrasive surface, the coffee beans are ground away from one side, namely the side facing the abrasive surface. The pressure which is needed for keeping the coffee beans to be ground in continuous contact with the abrasive surface is exerted on the basis of the fact that at least one of the grinding tool having the abrasive surface and at least a component of the bean positioning unit defining a space for accommodating a coffee bean is movably arranged in a direction for moving the abrasive surface and at least a component of the bean positioning unit apart or towards each other.

In the first basic embodiment of the grinder according to the present invention, grinding of coffee beans can take place at high speed with low torque. Among other things, this has the following advantages:

It is possible to apply a relatively cheap electro motor and to choose optimum settings for such a motor.

There is no need for a gearbox, or it is sufficient to apply only a small gearbox, so that space is saved, costs are reduced, and (energy) efficiency is increased.

Grinding of the coffee beans takes place in a very efficient process.

A smaller embodiment of the grinder is possible.

Less coffee residue remains in the grinder.

A level of noise associated with use of the grinder is reduced with respect to conventional situations.

Preferably, the bean positioning unit of the first basic embodiment of the grinder according to the present invention comprises a tube-shaped member, wherein one end of the tube-shaped member is open to an area of the abrasive surface, and wherein the bean positioning unit further comprises a rod which is slidably arranged inside the tube-shaped member. When a coffee bean is present in the tube-shaped member, the rod can be used for pressing the bean against the abrasive surface. While the bean is being ground away, the rod is continually moved in the direction of the abrasive surface in order to preserve contact between the coffee bean and the abrasive surface, thereby avoiding interruptions of the grinding process. Hence, it is advantageous if means are provided for exerting a pressure force on the rod.

The grinder may comprise a reservoir for containing a quantity of coffee beans to be ground, wherein the reservoir is connected to the tube-shaped member. The grinder may comprise means for transporting a bean to the tube-shaped member one bean at a time, but it is also possible that a batch containing a number of beans is allowed to fill the tube-shaped member in one go. In that case, the rod is arranged such as to be movable between a position where an end of the rod having a surface for contacting a coffee bean and pressing against a coffee bean is present at a back side of the tube-shaped member, i.e. at a side which is furthest away from the abrasive surface, and a position where the end of the rod as mentioned is present at a front side of the tube-shaped member, i.e. at a side which is closest to the abrasive surface. In other words, in that case, the rod is arranged such as to movable along the entire length of the tube-shaped member.

It is possible for a length of the tube-shaped member to be considerably larger than a diameter of the tube-shaped member, so that it is possible for the tube-shaped member to contain a string of coffee beans, wherein the coffee beans can be subjected to a grinding process, one after the other. When the tube-shaped member is filled with more than one coffee bean, the bean which is at the back is contacted by the rod, until this bean and all preceding beans are ground. In that case, the rod can be refracted so that the tube-shaped member can be filled again with a new batch of coffee beans.

In a practical embodiment, the grinding tool is rotatably arranged. For example, the abrasive surface can be part of a disc-shaped portion of the grinding tool, which portion may have a circular circumference, wherein the grinding tool is rotatable about a central axis of the portion. In that case, it is preferred if the space of the bean positioning unit is open to a non-central area of the grinding tool, so that it is achieved that a coffee bean can be put to contact with different areas of the abrasive surface, in a ring-shaped portion of the abrasive surface. Also, it is preferred if a mutual position of the grinding tool and the bean positioning unit in the second direction is adjustable, so that the mutual position may be changed from time to time, whereby it is achieved that when one ring-shaped portion of the abrasive surface is worn-out, another ring-shaped portion can be used for performing the grinding process.

In order to realize a situation in which more than one coffee bean is ground at one time in the first basic embodiment of the grinder according to the present invention, so that a shortest possible grinding time can be realized, it is possible to have more than one bean positioning unit and/or more than one grinding tool. In particular, according to a first possibility, the grinder comprises a combination of a grinding tool and at least two bean positioning units associated with the grinding tool. According to a second possibility, the grinder comprises at least two combinations of a grinding tool and a bean positioning unit associated with the grinding tool. As the grinder according to the present invention does not require much space, increasing a grinding capacity of the grinder by providing more than one bean positioning unit and/or more than one grinding tool is a feasible option.

Advantageous effects of the present invention appear from tests performed with a rotatably arranged grinding tool provided with a piece of sandpaper and an assembly of a tube-shaped member and a rod for holding and positioning the coffee beans and pressing the beans against the sandpaper, one after the other. As the tube-shaped member cannot be arranged such as to contact the sandpaper, in order to avoid undesired effects such as excessive wear of the sandpaper and a need for high power when it comes to realizing rotation of the sandpaper, a “double peak” particle size distribution as known from conventional, professional coffee grinders is realized. Hence, in the coffee powder which is obtained as a result of the grinding process, particles of various sizes are found, wherein the distribution of the sizes has two peaks. Furthermore, as a surprising effect, the coffee powder appears to be very fine when compared to a reference, which is a professional grinder at the finest setting.

In the tests, the time to grind a coffee bean was found to be about 0.25 seconds. Assuming that approximately 60 coffee beans are needed for one cup of coffee, the grind time appears to be about 15 seconds. However, the grind time associated with one cup does not need to be that long, as explained in the foregoing in respect of the possibilities of having more than one grinding tool and/or bean positioning unit in the grinder.

In a second basic embodiment of the grinder according to the present invention, at least a portion of the grinding tool is shaped like a cylinder having a circular circumference, wherein the grinder further comprises a housing having a grinding chamber, wherein the grinding tool is accommodated inside the grinding chamber, and wherein the grinding chamber is shaped like a funnel which is asymmetric with respect to a longitudinal axis of the cylinder-shaped portion of the grinding tool. In particular, the shape of the grinding chamber can be such that an area of a surface of the housing delimiting the grinding chamber extends substantially parallel with respect to the longitudinal axis as mentioned, wherein another area of the surface of the housing delimiting the grinding chamber extends at an angle with respect to the longitudinal axis. In this context, the angle as mentioned should be understood such as to be angle which is larger than 0°, so that a non-parallel configuration is obtained, wherein a practical value of the angle can be in a range of 15° to 45°, for example, wherein 30° can be a preferred value within that range. In respect of the design of the grinding tool, it is noted that the cylinder-shaped portion can have a tapering appearance, like a part of a cone, wherein the taper angle is preferably in a range of 5° to 25°. For sake of completeness, it is noted that other designs of the grinding tool and the grinding chamber are possible within the framework of the present invention. For example, the grinding chamber does not necessarily need to have an asymmetric appearance.

In a practical embodiment of the grinder, in order to achieve targets in respect of a grind size range, and also targets in respect of mass flow of the coffee beans, both a minimum and a maximum of a dimension of a gap between the abrasive surface of the grinding tool and a surface of the housing delimiting the grinding chamber are applicable at a position where the abrasive surface of the grinding tool is located closest to the surface of the housing. Preferably, the dimension of the gap as mentioned is in a range of 0.05 mm to 1 mm, wherein it is even more preferred to take into account a range of 0.1 mm to 0.5 mm.

Advantageously, the housing is located underneath a reservoir for containing a quantity of coffee beans, in an orientation in which the wide side of the funnel-shaped grinding chamber is present at the top for receiving the coffee beans from the reservoir. In such a case, the coffee beans automatically move to the more narrow portion of the funnel under the influence of gravity. In the process, the coffee beans are wedged between the abrasive surface of the grinding tool and a surface of the housing delimiting the grinding chamber, wherein the latter surface can be a smooth surface, i.e. a non-abrasive surface, as it has a primary function in retaining the coffee beans when they are in contact with the abrasive surface. As the grinding tool rotates and bits of the coffee beans are ground off, the coffee beans get smaller and move further down in the funnel-shaped grinding chamber, until they are so small that they can escape between the surface of the grinding tool and the surface of the housing delimiting the grinding chamber. In this respect, it is noted that it is advantageous for the housing to have an outlet for letting out coffee powder, which extends in a tangential direction with respect to the circumference of the cylinder-shaped portion of the grinding tool. The grind size of the coffee powder which is obtained when the second basic embodiment of the grinder according to the present invention is operated is determined by the size of a gap which is present between the abrasive surface of the grinding tool and the surface of the housing delimiting the grinding chamber at the position of the outlet, wherein the roughness of the abrasive surface is also an important factor. Preferably, a mutual position of the grinding tool and the housing is adjustable in a radial direction with respect to the longitudinal axis of the cylinder-shaped portion of the grinding tool, so that it is possible to adjust the grind size.

It is possible for the abrasive surface of the grinding tool to have a spiraling texture. An advantage of such a type of abrasive surface is that it is capable of grabbing the coffee beans, as it were, and helps in transporting the coffee beans downwards in the narrowing funnel-shaped grinding chamber.

The second basic embodiment of the grinder according to the present invention offers similar advantages as the first basic embodiment as presented earlier. It is emphasized that according to the present invention, grinding of coffee beans can take place at high speed with low torque, so that it is possible to apply a relatively cheap electro motor and to choose optimum settings for such a motor, wherein there is only a need for a small gearbox, or even no need at all for a gearbox, so that space is saved, costs are reduced, and (energy) efficiency is increased.

Besides the first basic embodiment and the second basic embodiment as described in the foregoing, other embodiments of the grinder according to the present invention are feasible. In general, in the first basic embodiment, the grinder comprises a grinding tool having an abrasive surface, and a bean positioning unit defining a space for accommodating a coffee bean, the space being open to an area of the abrasive surface, wherein at least one of the grinding tool and at least a component of the bean positioning unit is movably arranged in a first direction, for varying a distance between the abrasive surface and at least a component of the bean positioning unit, and wherein at least one of the grinding tool and the bean positioning unit is movably arranged in a second direction which is different from the first direction, for varying areas of the abrasive surface facing the open space of the bean positioning unit. In general, in the second basic embodiment, the grinder comprises a grinding tool having an abrasive surface, wherein at least a portion of the grinding tool is shaped like a cylinder having a circular circumference, and a housing having a grinding chamber, wherein the grinding tool extends inside the grinding chamber, wherein the grinding chamber is shaped like a funnel which is asymmetric with respect to a longitudinal axis of the cylinder-shaped portion of the grinding tool, and wherein at least one of the grinding tool and the housing is rotatably arranged in a direction about the longitudinal axis as mentioned, wherein it is preferred if the grinding tool is rotatable and the housing is fixed. All possible embodiments of the grinder according to the present invention are adapted to realize a grinding process in which the coffee beans are ground off bit by bit, as a result of the fact that the coffee beans are made to contact an abrasive surface of a grinding tool and are retained in the contacting position while a relative movement of the coffee beans and the abrasive surface takes place, contrary to a conventional grinding process in which the coffee beans are crushed.

The above-described and other aspects of the present invention will be apparent from and elucidated with reference to the following detailed description of two basic embodiments of a grinder according to the present invention. In the first basic embodiment, the grinder comprises a rotatably arranged grinding tool having an abrasive surface, wherein a functional portion of the tool is generally shaped like a disc, a tube-shaped member for feeding coffee beans to the abrasive surface, and a rod for pressing coffee beans against the abrasive surface. In the second basic embodiment, the grinder comprises a rotatably arranged grinding tool having an abrasive surface, wherein a functional portion of the tool is generally shaped like a cylinder having a circular circumference, and a housing with a funnel-shaped grinding chamber for accommodating the grinding tool.

### BRIEF DESCRIPTION OF THE DRAWINGS

The present invention will now be explained in greater detail with reference to the figures, in which equal or similar parts are indicated by the same reference signs, and in which:

FIG. 1 shows elements of a first basic embodiment of a grinder according to the present invention, including a reservoir for containing coffee beans, a grinding tool having an abrasive surface for grinding the coffee beans, a tube-shaped member for supplying the coffee beans to the abrasive surface, and a rod for pressing against the coffee beans inside the tube-shaped member;

FIG. 2 shows a view of a side of the grinding tool where the abrasive surface is present and illustrates how the tube-shaped member is positioned with respect to the grinding tool;

FIG. 3 shows elements of a second basic embodiment of a grinder according to the present invention, including a reservoir for containing coffee beans, a grinding tool having an abrasive surface for grinding the coffee beans, and a housing having a funnel-shaped chamber in which the grinding tool is present; and

FIG. 4 shows a section as taken along line A-A in FIG. 3.

The figures are of a diagrammatic nature and merely serve for providing an illustration of the aspects of the present invention, wherein the figures are not drawn to scale.

### DETAILED DESCRIPTION OF EMBODIMENTS

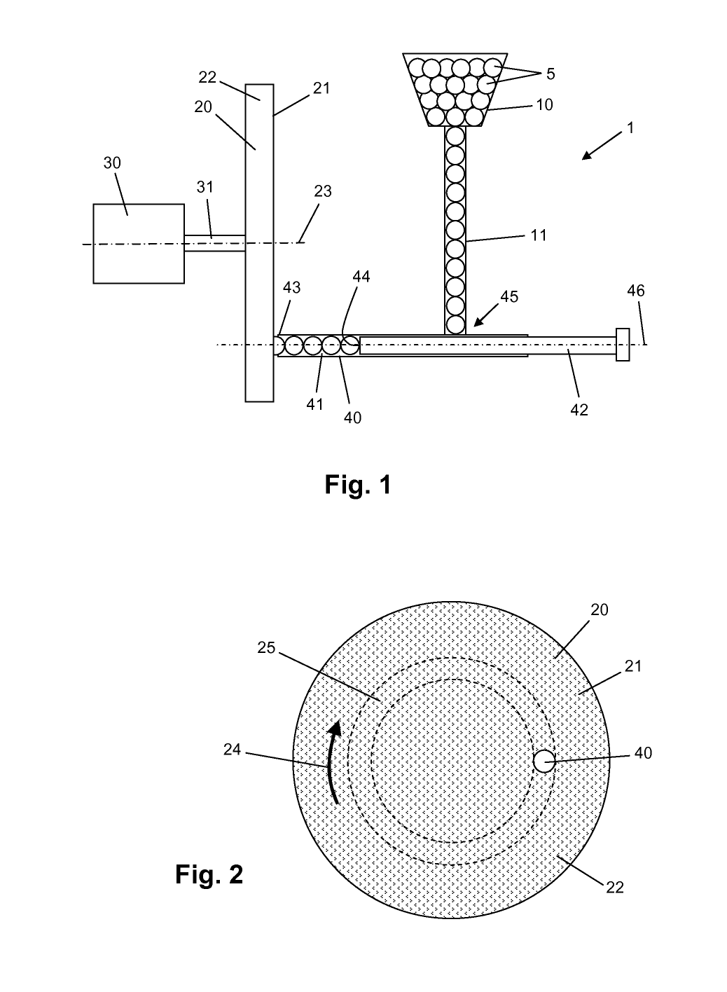

FIG. 1 shows elements of a first basic embodiment of a grinder 1 according to the present invention. The grinder 1 is a device which is adapted to perform a grinding process on coffee beans 5, which are diagrammatically shown in FIG. 1 as circles. By grinding the coffee beans 5, coffee powder is formed, which is suitable to be used in a process of making coffee by allowing a quantity of water to interact with the coffee powder, so that the coffee powder is extracted. The grinder 1 can be an integral part of a coffee maker, but it is also possible for the grinder 1 to be a stand-alone device.

The grinder 1 comprises a reservoir 10 for containing a plurality of coffee beans 5. For the purpose of performing a grinding action on the coffee beans 5, a grinding tool 20 having an abrasive surface 21 is provided. In the shown example, the grinding tool 20 comprises a disc-shaped portion 22 having a circular circumference, which is rotatable about a central axis 23. The abrasive surface 21 is present at a free side of the disc-shaped portion 22. At the other side of the disc-shaped portion 22, the grinding tool 20 is directly connected to a drive shaft 31 of a motor 30, which may be a simple electro motor.

FIG. 2 shows a side of the grinding tool 20 where the abrasive surface 21 is present. In this figure, it can be seen that in the shown example, the abrasive surface 21 covers the entire free side of the disc-shaped portion 22. For sake of completeness, it is noted that this is not essential within the scope of the present invention. Furthermore, a direction of a rotation movement of the grinding tool 20 about the central axis 23 of the disc-shaped portion 22, which is performed by the grinding tool 20 during a grinding process, is indicated by means of an arrow 24. The abrasive surface 21 may be a sandpaper surface, and may be arranged such as to be replaceable on the disc-shaped portion 22.

An essential difference between grinders known from the art and the grinder 1 according to the present invention is that in the grinders known from the art, the coffee beans 5 are supplied to a gap which is present between two grinding burrs, so that the beans 5 are crushed, while in the grinder 1 according to the present invention, coffee beans 5 are made to contact the abrasive surface 21 of the grinding tool 20 under pressure, one bean 5 after the other, so that the beans 5 are gradually ground away from one side, namely the side where the contact to the abrasive surface 21 takes place.

Various ways of realizing that coffee beans 5 and the abrasive surface 21 are pressed against each other are feasible within the framework of the present invention. For example, the grinder 1 may comprise a kind of gripper (not shown) having two arms for clamping a coffee bean 5, such that the coffee bean 5 is accommodated in a space between ends of the arms, wherein the gripper may be movable for putting the bean 5 in a position for contacting the abrasive surface 21 and maintaining the contact between the bean 5 and the abrasive surface 21 until the bean 5 is ground away. In the process, as the bean 5 gets smaller, the ends of the arms of the gripper are moved more and more towards the abrasive surface 21.

FIG. 1 illustrates a more practical option existing within the framework of the present invention. According to this option, the grinder 1 comprises a combination of a tube-shaped member 40 defining a space 41 for accommodating at least one coffee bean and a rod 42 which is slideably arranged inside the tube-shaped member 40. The tube-shaped member 40 may have a circular cross-section, wherein a diameter of the tube-shaped member 40 may be adapted to a diameter of the coffee beans 5 in such a way that the cross-section of the tube-shaped member 40 covers only one coffee bean 5. A free end 43 of the tube-shaped member 40 is arranged at a position close to the abrasive surface 21. In the shown example, a length of the tube-shaped member 40 is considerably larger than the diameter of the tube-shaped member 40, so that the tube-shaped member 40 can contain a string of beans 5 as shown in FIG. 1.

The rod 42 has a surface 44 for pressing against the beans 5 inside the tube-shaped member 40, so that it is possible to press the beans 5 against the abrasive surface 21 during a grinding process. Any suitable means may be applied for exerting the required pressure at the rod 42.

The tube-shaped member 40 is connected to the reservoir 10 by means of a conduit 11 which is suitable for transporting coffee beans 5 from the reservoir 10 to the tube-shaped member 40. FIG. 1 illustrates how the conduit 11 can be filled with a string of coffee beans 5. It is possible to have a suitable valve (not shown) or the like at a side of the conduit 11 which is connected to the reservoir 10 and/or a side of the conduit 11 which is connected to the tube-shaped member 40 in order to control a supply of beans 5 from the reservoir 10 to the tube-shaped member 40. In view of the fact that the rod 42 may be used for blocking and deblocking a bean entrance opening 45 of the tube-shaped member 40, such a valve can also be omitted. In any case, the tube-shaped member 40 can be filled with a number of coffee beans 5 when the rod 42 is in a retracted position, i.e. in a position furthest away from the free end 43 of the tube-shaped member 40.

FIG. 2 illustrates the fact that the tube-shaped member 40 is arranged at a position which is a non-central position with respect to the abrasive surface 21. On the basis of this arrangement of the tube-shaped member 40, it is achieved that when the grinding tool 20 is rotated about the central axis 23, the free end 43 of the tube-shaped member 40 is continually exposed to another area of the abrasive surface 21, inside a ring-shaped portion 25 of the abrasive surface 21 as indicated by a dashed line in FIG. 2. Advantageously, the mutual position of the abrasive surface 21 and the tube-shaped member 40 can be adjusted in such a way that the tube-shaped member 40 is made to cover another ring-shaped portion of the abrasive surface 21. In this way, it can be achieved that the entire abrasive surface 21 is used in grinding process before it is worn-out and needs to be replaced by a new one. It is also possible that the tube-shaped member 40 is arranged such as to be movable in an axial direction, i.e. a direction in which a longitudinal axis 46 of the tube-shaped member extends, if so desired, or that the tube-shaped member 40 has a tiltable arrangement, for example, so that the free end 43 of the tube-shaped member 40 can be moved away from the abrasive surface 21, which may be handy for various purposes, including cleaning purposes.

In the following, the functioning of the grinder 1 according to the present invention is further explained. A grinding process can take place when at least one coffee bean 5 is present inside the tube-shaped member 40. The coffee bean 5 can be put in the right position, i.e. a position in which it is present at the free end 43 of the tube-shaped member 40, with the help of the rod 42.

At the start of a grinding process, the motor 30 is activated so that the grinding tool 20 performs a rotation movement about the central axis 23. The speed of rotation is preferably in a range of 500 to 5,000 revolutions per minute, wherein it is even more preferred if the speed of rotation is in a range of 1,000 to 2,500 revolutions per minute, while the torque is preferably at most 2 Nm, wherein it is more preferred to have a torque of 1 Nm, and even more preferred to have a torque of at most 0.2 Nm. Pressure is exerted on the rod 42, so that the coffee bean 5 is pressed against the abrasive surface 21. As a result of the contact between the coffee bean 5 and the moving abrasive surface 21, the coffee bean 5 is ground. The rod 42 is gradually pressed in a direction towards the abrasive surface 21, while more and more of the coffee bean 5 is removed, and the process is continued until a last remainder of the coffee bean 5 is so small that it can escape between the free end 43 of the tube-shaped member 40 and the abrasive surface 21. Hence, the mutual position of the abrasive surface 21 and the tube-shaped member 40 in the direction of the longitudinal axis 46 of the tube-shaped member 40 is a determining factor in respect of the size of the largest particles in the coffee powder which is obtained as a result of the grinding process. Consequently, adjustment of the grind size can be achieved through adjustment of the mutual position as mentioned.

Basically, the grinding process to be performed by means of the grinder 1 involves a rotation movement of the grinding tool 20 and a gradual movement of the rod 42 in the direction of the abrasive surface 21, for pressing one coffee bean 5 after the other against the abrasive surface 21. When the last coffee bean 5 from a string of beans 5 has left the tube-shaped member 40, the rod 42 is retracted, so that the tube-shaped member 40 can be filled with a new string of beans 5 and the grinding process can be continued if so desired.

The coffee powder which is obtained as a result of the grind process is collected from the abrasive surface 21 in any suitable way. For example, a cup (not shown) or the like can be arranged at a suitable position underneath the grinding tool 20 for receiving the coffee powder which falls down into the cup under the influence of gravity in that arrangement.

In respect of the central axis 23 of the disc-shaped portion 22 of the grinding tool 20 and the longitudinal axis 46 of the tube-shaped member 40, it is noted that these axes 23, 46 can have the same orientation, but this is not necessary. In the shown example, both the central axis 23 of the disc-shaped portion of the grinding tool 20, which serves as a rotation axis 23 of the grinding tool 20, and the longitudinal axis 46 of the tube-shaped member 40 extend in a substantially horizontal direction. However, in a practical embodiment of the grinder 1 according to the present invention, the tube-shaped member 40 may have a tilted arrangement with respect to the horizontal, with the free end 43 at a lowest level, so that it is achieved that coffee beans 5 automatically move towards the free end 43 under the influence of gravity. This is most convenient when it comes to filling the tube-shaped member 40 with a number of beans 5.

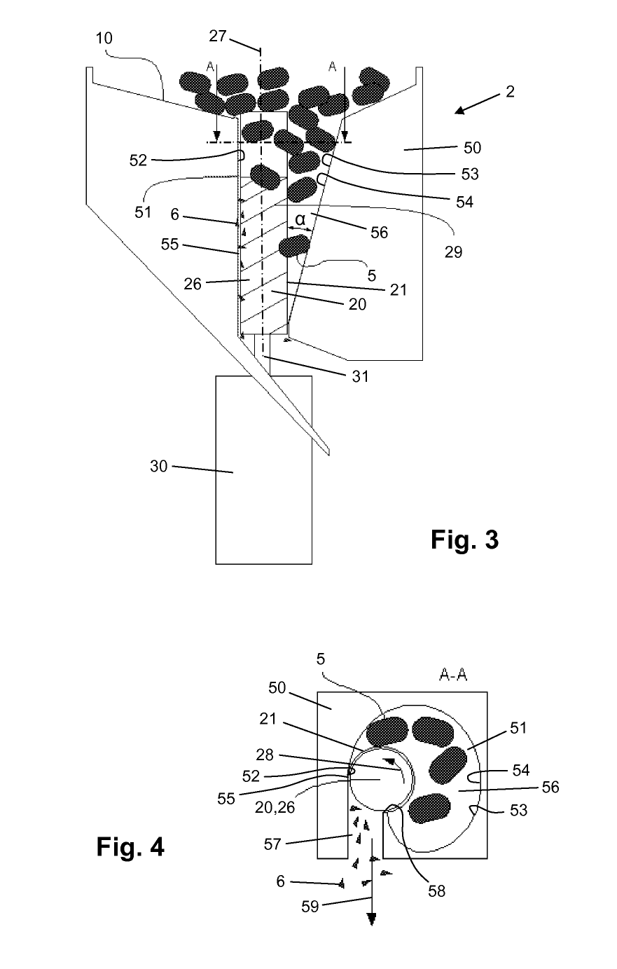

FIG. 3 shows elements of a second basic embodiment of a grinder 2 according to the present invention, and FIG. 4 shows a section as taken along a line A-A in FIG. 3. In the following, when terms such as top and bottom are used, these terms are to be understood such as to relate to the orientation of the grinder 2 as shown in FIG. 3, which is a normal, operational orientation. Thus, it can be said that FIG. 4 provides a top view of the section as indicated.

The grinder 2 is a device which is adapted to perform a grinding process on coffee beans 5, which are diagrammatically shown in FIGS. 3 and 4 as ellipses. By grinding the coffee beans 5, coffee powder is formed, which is suitable to be used in a process of making coffee by allowing a quantity of water to interact with the coffee powder, so that the coffee powder is extracted. The grinder 2 can be an integral part of a coffee maker, but it is also possible for the grinder 2 to be a stand-alone device.

The grinder 2 comprises a reservoir 10 for containing a plurality of coffee beans 5. For the purpose of performing a grinding action on the coffee beans 5, a grinding tool 20 having an abrasive surface 21 is provided. In the shown example, the grinding tool 20 comprises a cylinder-shaped portion 26 having a circular circumference, which is rotatable about a longitudinal axis 27, which axis 27 has a substantially vertical orientation in the shown example. A direction of a rotation movement of the grinding tool 20 about the longitudinal axis 27 of the cylinder-shaped portion 26, which is performed by the grinding tool 20 during a grinding process, is indicated by means of an arrow 28 in FIG. 4. The abrasive surface 21 is present at the curved cylinder wall of the cylinder-shaped portion 26. At one end of the cylinder-shaped portion 26, the grinding tool 20 is directly connected to a drive shaft 31 of a motor 30, which may be a simple electro motor.

Besides the grinding tool 20, the grinder 2 comprises a housing 50 for encompassing the cylinder-shaped portion 26 of the grinding tool 20. The housing 50 has a grinding chamber 51 for allowing the grinding tool 20 to extend inside the housing 50. In the shown example, the housing 50 is arranged right underneath the reservoir 10, so that the coffee beans 5 can be transported directly from the reservoir 10 to the grinding chamber 51.

The grinding chamber 51 is shaped like an asymmetric funnel, wherein an opening with the largest dimensions is present at the top, and wherein an opening with the smallest dimensions is present at the bottom. As seen in a sectional view taken in a vertical direction, one area 52 of a surface 53 of the housing 50 delimiting the grinding chamber 51, which surface 53 will hereinafter be referred to as delimiting surface 53, extends in a substantially vertical direction, i.e. a direction parallel to the longitudinal axis 27 of the cylinder-shaped portion 26 of the grinding tool 20 in the shown example, and another area 54 of the delimiting surface 53 is inclined with respect to the vertical, thereby being non-parallel to the longitudinal axis 27 as mentioned, as illustrated in FIG. 3. For example, an angle α between the inclined area 54 and the vertical may be about 15°. The cylinder-shaped portion 26 of the grinding tool 20 is arranged such as to extend near the vertical area 52, so that a small gap 55 is present between the abrasive surface 21 and that area 52, and a larger gap 56 which gradually gets smaller in a downward direction is present around a major part of the cylinder-shaped portion 26 of the grinding tool 20. Unlike the surface 21 of the grinding tool 20, the delimiting surface 53 does not need to have abrasive properties, so that it can have a smooth appearance instead.

FIG. 4 illustrates the fact that an outlet 57 for letting out bean particles which are obtained as a result of the grinding process preferably has a tangential orientation with respect to the circumference of the cylinder-shaped portion 26 of the grinding tool 20. Advantageously, a height (that is the dimension parallel to the longitudinal axis 27) of the outlet 57 is more or less the same as a height of the cylinder-shaped portion 26 of the grinding tool 20, so that bean particles can be removed from the grinding chamber 51 at any level, wherein accumulation of coffee powder in a bottom portion of the grinding chamber 51 is prevented. In order to prevent the coffee beans 5 from reaching the outlet 57 without being taken along with the grinding tool 20 as it rotates and without being ground at all, the delimiting surface 53 comprises another vertical area 58 for facing the abrasive surface 21 at a close distance.

An essential difference between grinders known from the art and the grinder 2 according to the present invention is that in the grinders known from the art, the coffee beans 5 are supplied to a gap which is present between two grinding burrs, while in the grinder 2 according to the present invention, coffee beans 5 are made to contact the abrasive surface 21 of the grinding tool 20 by letting them move downwards in a funnel-shaped grinding chamber 51 in which the grinding tool 20 is arranged. At a certain point, a coffee bean 5 is wedged between the abrasive surface 21 and the delimiting surface 53, as it were, wherein a bit of the bean 5 is ground off due to the fact that the abrasive surface 21 moves with respect to the bean 5. With every bit that is removed in this way, the bean 5 moves further down. It is advantageous if the abrasive surface 21 has a spiraling texture 29 as shown in FIG. 3, as such a texture 29 can have a function in grabbing the beans 5 and facilitating the desired downward movement of the beans 5. Eventually, as a result of the grinding process, a bean 5 is divided in numerous fragments 6, which are diagrammatically shown in FIGS. 3 and 4 as small triangles. When the fragments 6 are small enough to pass between the abrasive surface 21 and the vertical area 52 of the delimiting surface 53, the fragments 6 exit the grinding chamber 51 and enter the outlet 57. For sake of clarity, a direction in which the fragments 6 subsequently move through the outlet 57 is indicated by means of an arrow 59 in FIG. 4.

In comparison with prior art situations in which coffee beans 5 are ground between two grinding burrs, discharge of coffee grind is easier and more efficient, as the discharge takes place in the same direction as the movement of the grinding tool 20, i.e. as a tangent of the rotating movement of the grinding tool 20, wherein the coffee grind immediately exits an area where the grinding process takes place. In the prior art situations, the coffee grind needs to be discharged from an area between the grinding burrs, in a radial direction with respect to a rotation axis of the rotatable grinding burr, whereas the movement of the rotatable grinding burr is in another direction, namely in a direction around the rotation axis, which is a complicating factor in the discharge of the coffee grind.

In the following, the functioning of the grinder 2 according to the present invention is further explained. At the start of a grinding process, the motor 30 is activated so that the grinding tool 20 performs a rotation movement about the longitudinal axis 27 of the cylinder-shaped portion 26. The speed of rotation is preferably in a range of 500 to 5,000 revolutions per minute, wherein it is even more preferred if the speed of rotation is in a range of 1,000 to 2,500 revolutions per minute, while the torque is preferably at most 2 Nm, wherein it is more preferred to have a torque of 1 Nm, and even more preferred to have a torque of at most 0.2 Nm. A coffee bean 5 which is supplied from the reservoir 10 to the grinding chamber 51 gets stuck between the abrasive surface 21 and the delimiting surface 53. As a result of the contact between the coffee bean 5 and the moving abrasive surface 21, the coffee bean 5 is ground. As the coffee bean 5 gets smaller, it gradually moves in a downward direction, while more and more of the coffee bean 5 is removed, and the process is continued until a last remainder of the coffee bean 5 is so small that it can escape between the delimiting surface 53 and the abrasive surface 21. Hence, the size of the small gap 55 between the abrasive surface 21 and the vertical area 52 of the delimiting surface 53 is a determining factor in respect of the size of the largest particles in the coffee powder which is obtained as a result of the grinding process. Consequently, adjustment of the grind size can be achieved through adjustment of the size of the small gap 55.

Basically, the grinding process to be performed by means of the grinder 2 involves a rotation movement of the grinding tool 20 and a gradual movement of the coffee beans 5 from the widest part to the narrowest part of the funnel-shaped grinding chamber 51, wherein bean fragments 6 are obtained which are small enough to exit the grinding chamber 51 at the position of the outlet 57.

For sake of completeness, it is noted that the grinder 2 may have another orientation than the orientation in which gravity helps in letting the coffee beans 5 move from the reservoir 10 to the grinding chamber 51, and letting the beans 5 perform a downward movement through the grinding chamber 51. However, making use of gravity in that way is an interesting option, as there is no need for exerting pressure in some way in order to realize the desired movements of the beans 5. That does not alter the fact that an orientation which may be denoted as being a horizontal orientation rather than a vertical orientation can also be advantageous. For example, in a horizontal orientation, a supply of the coffee beans 5 can take place in a radial direction, and a build height of the grinder can be reduced.

On the basis of tests which have been performed in the context of the present invention, ranges of practical dimensions of the grinder 2 have been found. In particular, in order to achieve targets in respect of a grind size range, it has been found that at the position of the small gap 55, it is advantageous for a sum of the size of the small gap 55 and a teeth depth of the abrasive surface 21 of the grinding tool 20 to be at most 2 mm, preferably at most 1 mm. In order to achieve both grind size range targets and targets in respect of mass flow of the coffee beans 5, it is advantageous if the size of the small gap 55 is below 1 mm, preferably below 0.5 mm, yet larger than 0.05 mm, preferably larger than 0.1 mm. In respect of the values of the size of the small gap 55 as mentioned, it is noted that these values are measured between the delimiting surface 53 of the housing 50 and a top level of teeth of the abrasive surface 21 of the grinding tool 20.

It has appeared that there is a practical maximum of the teeth depth in view of a desired practical range of the grind size, which range is 300 to 700 μm, for example. If the teeth depth would be too big, it would not be possible to realize this range completely. On the other hand, there is a practical minimum of the teeth depth. If the teeth depth would be too small, difficulties in a process of grabbing coffee beans 5 would arise. Also, there would be difficulties in manufacturing the grinding tool 20 having the abrasive surface 21.

It is noted that it is a practical possibility for the abrasive surface 21 of the grinding tool 20 to comprise at least two sections which are mutually different, at least as far as the dimensions of the teeth constituting the abrasive surface 21 are concerned. For example, there may be a first section having relatively large teeth which is suitable to be used for grinding whole coffee beans 5 to a first, coarse grind, and there may be a second section having relatively small teeth which is suitable to be used for grinding the first, coarse grind to a final, fine grind. Naturally, in such a case, the first section is located at a side of the grinding chamber 51 where the coffee beans 5 enter the grinding chamber 51.

It will be clear to a person skilled in the art that the scope of the present invention is not limited to the examples discussed in the foregoing, but that several amendments and modifications thereof are possible without deviating from the scope of the present invention as defined in the attached claims. While the present invention has been illustrated and described in detail in the figures and the description, such illustration and description are to be considered illustrative or exemplary only, and not restrictive. The present invention is not limited to the disclosed embodiments.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the present invention.

The present invention relates to a method for grinding coffee beans 5, and also relates to a device 1, 2 for grinding coffee beans 5. In a first basic embodiment, the device 1 comprises a grinding tool 20 having an abrasive surface 21, and a bean positioning unit 40, 42 defining a space 41 for accommodating a coffee bean 5, the space 41 being open to an area of the abrasive surface 21. At least one of the grinding tool 20 and at least a component 42 of the bean positioning unit 40, 42 is movably arranged in a first direction, for varying a distance between the abrasive surface 21 and at least a component 42 of the bean positioning unit 40, 42. In this way, it is possible for a coffee bean 5 and the abrasive surface 21 to be pressed against each other, so that the abrasive surface 21 can perform a grinding action on the coffee bean 5 when the abrasive surface 21 and the coffee bean 5 are made to perform a movement with respect to each other in a second direction which is different from the first direction. The mutual movement of the abrasive surface 21 and the coffee bean 5 as mentioned can be realized on the basis of the fact that at least one of the grinding tool 20 and the bean positioning unit 40, 42 is movably arranged in the second direction as mentioned, for varying areas of the abrasive surface 21 facing the open space 41 of the bean positioning unit 40, 42.

In a practical embodiment, the bean positioning unit 40, 42 comprises a tube-shaped member 40, wherein one end 43 of the tube-shaped member 40 is open to an area of the abrasive surface 21, and wherein the bean positioning unit 40, 42 further comprises a rod 42 which is slidably arranged inside the tube-shaped member 40. In that case, the first direction can be a direction in which a longitudinal axis 46 of the tube-shaped member 40 is orientated. Furthermore, the grinding tool 20 can be arranged such as to be rotatable about a rotation axis 23. In that case, the second direction can be a direction perpendicular to a direction in which the rotation axis 23 is orientated.

In a second basic embodiment, the device 2 according to the present invention comprises a grinding tool 20 having an abrasive surface 21, wherein at least a portion 26 of the grinding tool 20 is shaped like a cylinder having a circular circumference, and a housing 50 having a grinding chamber 51, wherein the grinding tool 20 extends inside the grinding chamber 51. The grinding chamber 51 is shaped like an asymmetric funnel, and the cylinder-shaped portion 26 of the grinding tool 20 is arranged such as to extend close to an area 52 of a surface 53 of the housing 50 delimiting the grinding chamber 51. When a coffee bean 5 is received in the grinding chamber 51, the bean 5 is moved from the widest part of the funnel shape to the narrowest part of the funnel shape, in the free space which is not occupied by the cylinder-shaped portion 26 of the grinding tool 20, while the grinding tool 20 is rotated about a longitudinal axis 27 of the cylinder-shaped portion 26. In the process, the bean 5 is continually wedged between the abrasive surface 21 and the surface 53 of the housing 50 delimiting the grinding chamber 51, wherein the bean 5 is gradually ground away under the influence of contact to the abrasive surface 21, until a last remainder of the bean 5 is small enough to escape between the abrasive surface 21 and the surface 53 of the housing 50 delimiting the grinding chamber 51.

By grinding off coffee beans 5 instead of crushing coffee beans 5 in a conventional manner, it is achieved that the grinding process can be performed at a relatively high speed and a relatively low torque, so that a relatively small and cheap motor 30 can be used for realizing a relative movement of the abrasive surface 21 and the coffee beans 5, wherein there is no need for applying a gearbox, or wherein it suffices to apply a small gearbox having a low transmission ratio. Preferably, the relative movement involves rotation, wherein the speed is speed is in a range of 500 to 5,000 revolutions per minute, or in a range of 1,000 to 2,500 revolutions per minute. Furthermore, it is preferred to have a driving torque which is at most 2 Nm, and it is even more preferred to have a driving torque which is at most 1 Nm, or even at most 0.2 Nm.

Within the framework of the present invention, it is possible for coffee grind as obtained by grinding the coffee beans 5 to be discharged from a position between the grinding tool 20 and the bean delimiting tool 40, 42; 50 by moving in the same direction as the grinding tool 20. Such an easy and efficient discharge of coffee grind is an advantageous possibility, which is surprisingly found with the present invention.

In a second aspect, the present invention relates to a method for grinding coffee beans 5, wherein the coffee beans 5 are ground by applying a device 1, 2 comprising two tools 20; 40, 42; 50, wherein at least one of the tools 20; 40, 42; 50 is a grinding tool 20 having an abrasive surface 21, and wherein coffee grind as obtained by grinding the coffee beans 5 is discharged from a position between the grinding tool 20 and the bean delimiting tool 40, 42; 50 by moving in the same direction as the grinding tool 20. Also, the present invention relates to a device 2 for grinding coffee beans 5, comprising at least one grinding tool 20 having an abrasive surface 21, and means 30 for realizing a relative movement of the coffee beans 5 and the abrasive surface 21, wherein at least a portion 26 of the grinding tool 20 is shaped like a cylinder having a circular circumference, and wherein the device 2 further comprises an outlet 57 for letting out coffee grind, which has a tangential orientation with respect to the circumference of the cylinder-shaped portion 26 of the grinding tool 20.

1. Method for grinding coffee beans, wherein the coffee beans are ground off bit by bit by applying a device comprising two tools, wherein one of the tools is a grinding tool having an abrasive surface, wherein the coffee beans and the abrasive surface are made to contact each other and to perform a relative movement with respect to each other, and wherein another of the tools is a bean delimiting tool having a surface against which the coffee beans are retained during the time that they are in contact with the abrasive surface.

2. Method according to claim 1, wherein the grinding tool is rotated at a speed which is at least 500 revolutions per minute.

3. Method according to claim 2, wherein the grinding tool is driven at a typical torque which is at most 2 Nm.

4. Method according to claim 1, wherein coffee grind as obtained by grinding the coffee beans is discharged from a position between the grinding tool and the bean delimiting tool by moving in the same direction as the grinding tool.

5. Device for grinding coffee beans, comprising a grinding tool having an abrasive surface, a bean delimiting tool for putting the coffee beans and the grinding tool in a position for contacting each other, the bean delimiting tool having a surface for retaining the coffee beans in such position, and means for realizing a relative movement of the coffee beans and the abrasive surface.

6. Device according to claim 5, wherein the surface of the bean delimiting tool is a non-abrasive surface.

7. Device according to claim 5, comprising a motor for driving the grinding tool wherein the grinding tool is directly connected to an outgoing shaft of the motor.

8. Device according to claim 5, wherein the grinding tool is rotatably arranged in the device, and wherein the means for realizing a relative movement of the coffee beans and the abrasive surface are adapted to rotate the grinding tool at a speed which is at least 500 revolutions per minute.

9. Device according to claim 8, wherein the means for realizing a relative movement of the coffee beans and the abrasive surface are adapted to drive the grinding tool at a typical torque which is at most 2 Nm.

10. Device according to claim 5, comprising a bean positioning unit defining a space for accommodating a coffee bean, the space being open to an area of the abrasive surface of the grinding tool wherein at least one of the grinding tool and at least a component of the bean positioning unit is movably arranged in a first direction, for varying a distance between the abrasive surface and at least a component of the bean positioning unit, and wherein at least one of the grinding tool and the bean positioning unit is movably arranged in a second direction which is different from the first direction, for varying areas of the abrasive surface facing the open space of the bean positioning unit.

11. Device according to claim 10, wherein the grinding tool is rotatable about a central axis, and wherein the space of the bean positioning unit is open to a non-central area of the grinding tool.

12. Device according to claim 5, wherein at least a portion of the grinding tool is shaped like a cylinder having a circular circumference, wherein the device further comprises a housing having a grinding chamber, wherein the grinding tool is accommodated inside the grinding chamber, and wherein the grinding chamber is shaped like a funnel which is asymmetric with respect to a longitudinal axis of the cylinder-shaped portion of the grinding tool.

13. Device according to claim 12, wherein, at a position where the abrasive surface of the grinding tool is located closest to a surface of the housing delimiting the grinding chamber, a gap between the abrasive surface of the grinding tool and the surface of the housing is at least 0.05 mm and at most 1 mm.

14. Device according to claim 12, comprising an outlet for letting out coffee grind, which has a tangential orientation with respect to the circumference of the cylinder-shaped portion of the grinding tool.

15. Coffee maker, comprising a brewing space for allowing coffee extract to interact with water, and further comprising a device for grinding coffee beans according to claim 5.
